(19) United States
(12) Patent Application Publication
(10) Pub. No.: US 2025/0392001 A1
(43) Pub. Date: Dec. 25, 2025

(54) ELECTROCHEMICAL DEVICE SEPARATOR, MANUFACTURING METHOD THEREOF, AND ELECTROCHEMICAL DEVICE INCLUDING THE SAME

(71) Applicant: LG ENERGY SOLUTION, LTD., Seoul (KR)

(72) Inventors: Ji Eun KIM, Daejeon (KR); Dong Wook SUNG, Daejeon (KR); Ji Yeon KIM, Daejeon (KR); Yong Hyeok LEE, Daejeon (KR); Yoo Jin LEE, Daejeon (KR)

(73) Assignee: LG ENERGY SOLUTION, LTD., Seoul (KR)

(21) Appl. No.: 19/242,271

(22) Filed: Jun. 18, 2025

(30) Foreign Application Priority Data
Jun. 20, 2024 (KR) 10-2024-0080118
Jun. 17, 2025 (KR) 10-2025-0079349

(51) Int. Cl. H01M 50/42; H01M 50/403; H01M 50/434; H01M 50/443; H01M 50/446; H01M 50/457

(52) U.S. Cl. CPC H01M 50/42; H01M 50/403; H01M 50/434; H01M 50/443; H01M 50/446; H01M 50/457

(57) ABSTRACT

The present disclosure relates to an electrochemical device separator, which includes an adhesive layer containing a small amount of water-soluble polymer binder on a coating layer to enhance the adhesion between the separator and the electrodes, and further, suppress the increase in air permeability and resistance of the separator, an electrochemical device including the same, and a manufacturing method thereof.

### CROSS REFERENCES TO RELATED APPLICATIONS

This application is based on and claims priority from Korean Patent Application No. 10-2024-0080118, filed on Jun. 20, 2024, and No. 10-2025-0079349, filed on Jun. 17, 2025, with the Korean Intellectual Property Office, the disclosure of which is incorporated herein in its entirety by reference.

### TECHNICAL FIELD

The present disclosure relates to an electrochemical device separator, a manufacturing method thereof, and an electrochemical device including the same.

### BACKGROUND

An electrochemical device such as a lithium-ion battery is a battery that can be charged and discharged repeatedly, and serves as an energy storage device capable of storing electrical energy as chemical energy and converting the chemical energy back into electricity as needed. In general, the electrochemical device is configured with a positive electrode, a negative electrode, a separator, and an electrolyte.

Of the components of the electrochemical device, the separator includes a porous polymer substrate disposed between the positive electrode and the negative electrode, and takes on the role of separating the positive electrode and the negative electrode, preventing an electrical short circuit between the two electrodes, and allowing the passage of electrolyte and ions. While the separator itself does not participate in electrochemical reactions, its physical properties such as the wettability to the electrolyte, the degree of porosity, and the thermal shrinkage rate affect the performance and the safety of the electrochemical device.

### SUMMARY

The present disclosure provides an electrochemical device separator, which includes an adhesive layer containing a small amount of water-soluble polymer binder on a coating layer to enhance the adhesion between the separator and the electrodes, a manufacturing method thereof, and an electrochemical device including the same.

Advantages of the present disclosure are not limited to those described above, and one of ordinary skill in the art of the present disclosure can clearly understand other advantages from the descriptions herein below.

An embodiment of the present disclosure provides an electrochemical device separator including: a porous polymer substrate; a coating layer provided on at least one surface of the porous polymer substrate, and including inorganic particles; and an adhesive layer including a first polymer binder and a second polymer binder on the coating layer, wherein the first polymer binder is a water-soluble polymer binder.

According to an embodiment of the present disclosure, the second polymer binder is a water-insoluble polymer binder.

According to an embodiment of the present disclosure, a content ratio of the first polymer binder and the second polymer binder is about 1:99 to 19:81.

According to an embodiment of the present disclosure, the first polymer binder is one selected from polyacrylic acid (PAA), polyacrylamide (PAM), polyvinyl alcohol (PVA), a phosphoric acid ester-based copolymer, a phosphoric acid acrylic-based copolymer, a polyacrylate-based copolymer, and combinations thereof.

According to an embodiment of the present disclosure, the second polymer binder is a polyvinylidene-based binder or an acrylic-based binder.

According to an embodiment of the present disclosure, a content of the inorganic particles in the coating layer is about 80 parts by weight or more based on 100 parts by weight of the coating layer.

According to an embodiment of the present disclosure, a thickness ratio of the coating layer and the adhesive layer is about 1:1 to 3:1.

According to an embodiment of the present disclosure, a thickness of the coating layer is about 5.0 μm or less.

According to an embodiment of the present disclosure, a thickness of the adhesive layer is about 3.0 μm or less.

According to an embodiment of the present disclosure, an adhesion of the electrochemical device separator is about 10 gf/20 mm or more.

According to an embodiment of the present disclosure, an air permeability of the electrochemical device separator is about 100 sec/100 cc or less.

According to an embodiment of the present disclosure, a resistance (52) of the electrochemical device separator is about 0.80 ohm or less.

Another embodiment of the present disclosure provides a method of manufacturing an electrochemical device separator, the method including: preparing a porous polymer substrate; coating at least one surface of the porous polymer substrate with a slurry including inorganic particles to form a coating layer; and applying a slurry including a first polymer binder and a second polymer binder onto the coating layer to form an adhesive layer, wherein the first polymer binder is a water-soluble polymer binder.

Yet another embodiment of the present disclosure provides an electrochemical device including: a positive electrode; a negative electrode; a separator interposed between the positive electrode and the negative electrode; and an electrolyte, wherein the separator is any one of the aforementioned electrochemical device separators.

According to an embodiment of the present disclosure, the electrolyte is an electrolyte including one solvent selected from ethylene carbonate (EC), diethyl carbonate (DEC), dimethyl carbonate (DMC), ethyl methyl carbonate (EMC), and combinations thereof.

In the electrochemical device separator according to an embodiment of the present disclosure, the water-soluble polymer binder contained in a small amount in the adhesive layer may enhance the adhesion between the electrodes and the binder.

The electrochemical device separator according to an embodiment of the present disclosure may enhance the adhesion to the electrodes, and simultaneously, suppress the increase in air permeability and resistance of the separator.

The method of manufacturing the electrochemical device separator according to an embodiment of the present disclosure may enhance the adhesion between the electrodes and the separator, and suppress the increase in air permeability and resistance of the separator.

The electrochemical device according to an embodiment of the present disclosure may improve the battery performance.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a schematic view of an electrochemical device separator according to an embodiment of the present disclosure.

Corresponding reference characters indicate corresponding components throughout the several views of the drawings, but different reference characters may be given as necessary. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

In the descriptions herein below, when a certain part “includes” a specific component, this description does not indicate that the certain part excludes other components, but indicates that the part may further include other components, unless otherwise defined.

In the descriptions herein below, the expression “A and/or B” indicates “A and B, or A or B.”

In the descriptions herein below, when a component is disposed “on” a specific part, this description does not exclude a case where another component is disposed between the component and the specific part, but indicates that another component may be further disposed therebetween, unless otherwise described.

In the descriptions herein below, when an object includes “pores,” this description indicates that the object has a plurality of pores connected to each other, and this structure may allow vapor and/or liquid fluid to pass through the pores from one side to the other side of the object.

In the descriptions herein below, a separator has the porous characteristics including a plurality of pores, and serves as a porous ion-conducting barrier that allows the passage of ions while blocking an electrical contact between the negative electrode and the positive electrode in the electrochemical device.

In order to enhance the physical properties of the separator, which is a component of the electrochemical device, various methods are being attempted, for example, forming a coating layer on a porous polymer substrate, and adding diverse substances to the coating layer to alter the physical properties of the coating layer. For instance, an inorganic substance may be added to the coating layer for the purpose of improving the mechanical strength of the separator, or an inorganic substance or hydrate may be added to the coating layer for the purpose of improving the fire resistance and the heat resistance of the polymer substrate.

When the adhesion between the separator and the electrodes is possible, an assembly process using lamination, hot pressing and so on may be applied, and there are advantages in that the electrode interface and the separator may be closely adhered, and the strength of a battery cell may be ensured even under the injection of an electrolyte.

When adhering the separator and the electrodes, an adhesive layer may be coated on the surface of the separator, and several types of polymers are applied to the adhesive layer. For example, a water-insoluble polymer compound, which is insoluble in water, may be used as an adhesive layer binder. This compound is an emulsion dispersed in water or a binder in the form dispersed in water through a suspension polymerization or a post-processing, but such a binder, in its droplet-like form, has a limitation in enhancing the adhesion between the electrodes and the separator.

In order to solve the problem of the water-insoluble polymer compound used as the adhesive layer binder, the present disclosure provides a separator, which may enhance the adhesion to the electrodes, and suppress the increase in air permeability and resistance.

Hereinafter, the present disclosure will be described in more detail with reference to the accompanying drawings.

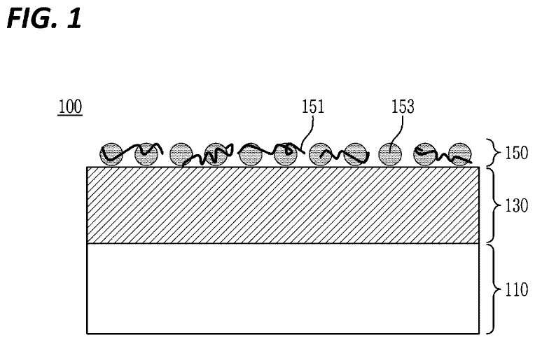

FIG. 1 is a schematic view of an electrochemical device separator according to an embodiment of the present disclosure.

According to an embodiment of the present disclosure, an electrochemical device separator 100 includes: a porous polymer substrate 110; a coating layer 130 provided on at least one surface of the porous polymer substrate and containing inorganic particles; and an adhesive layer 150 including a first polymer binder 151 and a second polymer binder 153 on the coating layer 130, wherein the first polymer binder 151 is a water-soluble polymer binder.

In the electrochemical device separator 100 according to an embodiment of the present disclosure, the water-soluble polymer binder included in a small amount in the adhesive layer 150 may enhance the adhesion between the electrode and the binder. Further, the electrochemical device separator 100 according to an embodiment of the present disclosure may suppress the increase in air permeability and resistance of the separator, in addition to enhancing the adhesion to the electrodes.

According to an embodiment of the present disclosure, the electrochemical device separator 100 includes the porous polymer substrate 110. In this way, the electrochemical device separator 100 includes the porous polymer substrate, so that the separator may allow the passage of lithium ions while blocking an electrical contact, and implement the shutdown performance at an appropriate temperature.

According to an embodiment of the present disclosure, the porous polymer substrate 110 may be manufactured using a polyolefin-based resin as a base resin. Examples of the polyolefin-based resin include polyethylene, polypropylene, and polypentene, and the polyolefin-based resin may include at least one thereof. When the separator is manufactured using the polyolefin-based resin as a base resin to have a porosity, for example, a large number of pores, it is advantageous from the viewpoint of implementing the shutdown performance at an appropriate temperature.

According to an embodiment of the present disclosure, the weight-average molecular weight of the polyolefin-based resin may be about 500,000 to 1,500,000. By adjusting the weight-average molecular weight of the polyolefin-based resin in this range, the compression resistance of the separator may be improved. Further, when different types of polyolefin-based resins are blended or used in a multilayer structure to form the separator, the weight-average molecular weight of the polyolefin-based resin may be calculated by summing the weight-average molecular weights of the individual polyolefin-based resins according to the content ratio thereof.

In the descriptions herein, the weight-average molecular weight (Mw) may be measured by gel permeation chromatography (GPC, PL GPC220, Agilent Technologies), and measurement conditions may be set as follows:
Column: PL Olexis (Polymer Laboratories)
Solvent: TCB (Trichlorobenzene)
Flow rate: 1.0 ml/min
Sample concentration: 1.0 mg/ml
Injection amount: 200 μl
Column temperature: 160° C.
Detector: Agilent High Temperature RI detector
Standard: Polystyrene (calibrated with a cubic function)

According to an embodiment of the present disclosure, the porous polymer substrate 110 may be manufactured using a method (wet method), which kneads the polyolefin-based resin with a diluent at a high temperature to form a single phase, extracts the diluent to form pores after a phase separation of the polymer material and the diluent through a cooling process, and then, stretches and thermally secures the polymer material.

According to an embodiment of the present disclosure, one of ordinary skill in the art may easily prepare the average size and the maximum size of the pores of the electrochemical device separator 100 to conform to the scope of the present disclosure, by adjusting, for example, the mixing ratio of the diluent, the stretching rate, and the temperature for a thermal securing process.

According to an embodiment of the present disclosure, the electrochemical device separator 100 includes the coating layer 130 provided on at least one surface of the porous polymer substrate 110. For example, the electrochemical device separator 100 includes the coating layer 130 provided on one surface or both surfaces of the porous polymer substrate 110. In this way, the electrochemical device separator 100 includes the coating layer 130 provided on at least one surface of the porous polymer substrate 110, so that the heat resistance and the mechanical properties of the separator 100 may be improved, and it is possible to prevent or suppress the occurrence of an electrical short circuit at the electrodes resulting from the shrinkage of the separator 100 at a high temperature.

According to an embodiment of the present disclosure, the coating layer 130 includes inorganic particles. In this way, the coating layer 130 includes the inorganic particles, so that the heat resistance and the mechanical properties of the separator 100 may be improved, thereby preventing or suppressing the occurrence of an electrical short circuit at the electrodes resulting from the shrinkage of the separator at a high temperature, and pores may be formed inside the coating layer 130.

According to an embodiment of the present disclosure, the coating layer 130 may further include a third polymer binder. In this way, the coating layer 130 includes the third polymer binder and the inorganic particles, so that the heat resistance and the mechanical properties of the separator 100 may be improved, thereby preventing or suppressing the occurrence of an electrical short circuit at the electrodes resulting from the shrinkage of the separator at a high temperature, and pores may be formed inside the coating layer 130.

According to an embodiment of the present disclosure, the coating layer 130 may be formed in the manner that the inorganic particles are bonded by particles of the third polymer binder and aggregated in the layer. The pores in the coating layer 130 may result from interstitial volumes that are voids among the inorganic particles.

According to an embodiment of the present disclosure, the coating layer 130 may include a plurality of pores. For example, the coating layer 130 may be a porous coating layer. According to an embodiment, the coating layer 130 may be a porous coating layer including a plurality of pores therein. In this way, the coating layer 130 includes the plurality of pores, so that the coating layer 130 may allow the passage of lithium ions to cause the flow of current while physically blocking the positive electrode and the negative electrode.

According to an embodiment of the present disclosure, the third polymer binder may be a water-soluble or water-insoluble polymer binder. By selecting the first polymer binder from the materials described above, the porosity and the air permeability of the coating layer may be adjusted, the size of the pores of the coating layer 130 may be adjusted, and the mechanical properties of the coating layer 130 may be improved.

According to an embodiment of the present disclosure, the third polymer binder may be an acrylic-based binder, a polyvinylidene-based binder, or a combination thereof. As described above, by selecting the first polymer binder from the materials described above, the heat resistance of the coating layer 130 may be improved, and the bonding force of the inorganic particles in the coating layer 130 may be improved.

According to an embodiment of the present disclosure, the third polymer binder may be an acrylic-based binder. The porosity of the separator 100 may be maintained, the adhesion between the electrodes and the separator 100 during a battery lamination process may be enhanced, which may improve the ease of the manufacturing of the battery, and a stacking process may be stably performed.

According to an embodiment of the present disclosure, the acrylic-based binder is a polymer including carboxylic acid ester as a repeating unit, and may be, for example, a (meth)acrylic acid ester or an acrylic-styrene copolymer.

According to an embodiment of the present disclosure, examples of the (meth)acrylic acid ester include (meth)acrylic acid methyl, (meth)acrylic acid ethyl, (meth)acrylic acid n-propyl, (meth)acrylic acid i-propyl, (meth)acrylic acid n-butyl, (meth)acrylic acid i-butyl, (meth)acrylic acid n-amyl, (meth)acrylic acid i-amyl, (meth)acrylic acid hexyl, (meth)acrylic acid cyclohexyl, (meth)acrylic acid 2-ethylhexyl, (meth)acrylic acid n-octyl, (meth)acrylic acid nonyl, (meth)acrylic acid decyl, (meth)acrylic acid hydroxymethyl, (meth)acrylic acid hydroxyethyl, (meth)acrylic acid ethylene glycol, di(meth)acrylic acid ethylene glycol, di(meth)acrylic acid propylene glycol, tris(meth)acrylic acid trimethylolpropane, tetra(meth)acrylic acid pentaerythritol, hexa(meth)acrylic acid dipentaerythritol, (meth)acrylic acid allyl, and di(meth)acrylic acid ethylene, and the (meth)acrylic acid ester may be at least one selected therefrom. The (meth)acrylic acid ester may be at least one selected from (meth)acrylic acid methyl, (meth)acrylic acid ethyl, and (meth)acrylic acid 2-ethylhexyl, and may be (meth)acrylic acid methyl according to an embodiment.

According to an embodiment of the present disclosure, the acrylic-styrene copolymer may include an acrylic-based binder, and the acrylic-based binder may be a polyacrylate-based binder. For example, the binder may be at least one selected from a styrene-butadiene rubber, a nitrile-butadiene rubber, an acrylonitrile-butadiene rubber, an acrylonitrile-butadiene-styrene rubber, and an acrylate-based polymer, and particularly, may be a copolymer including acrylate.

According to an embodiment of the present disclosure, the polyvinylidene-based binder included in the third polymer binder may be a polyvinylidene difluoride (PVdF)-based binder. In this way, the polyvinylidene difluoride-based binder is selected as the polyvinylidene-based binder, so that the resistance of the separator 100 may be reduced.

According to an embodiment of the present disclosure, the polyvinylidene-based binder may be a copolymer of polyvinylidene fluoride and hexafluoropropylene (PVdF-co-HFP, poly(vinylidene fluoride-co-hexafluoropropylene)). In this way, the copolymer of polyvinylidene fluoride and hexafluoropropylene is selected as the polyvinylidene-based binder, so that the dissolution of the polymer binder by the electrolyte may be minimized.

According to an embodiment of the present disclosure, in the polyvinylidene-based binder included in the third polymer binder, the content of hexafluoropropylene may be about 5 wt % or more. For example, in the polyvinylidene-based binder included in the third polymer binder, the content of hexafluoropropylene may be about 5 wt % to 80 wt %, about 15 wt % to 75 wt %, about 20 wt % to 70 wt %, about 25 wt % to 65 wt %, about 30 wt % to 60 wt %, about 35 wt % to 55 wt %, or about 40 wt % to 50 wt %. By adjusting the content of hexafluoropropylene included in the polyvinylidene-based binder of the third polymer binder within the range described above, the resistance of the separator 100 may be reduced. The content of the hexafluoropropylene (HFP) monomer may be measured by 1H-NMR and/or 19F-NMR.

According to an embodiment of the present disclosure, the third polymer binder may be hybrid binder particles including an acrylic-based binder and a polyvinylidene-based binder. In this way, the hybrid binder particles including the acrylic-based binder and the polyvinylidene-based binder are selected as the third polymer binder, so that the adhesion to the electrodes may be enhanced.

According to an embodiment of the present disclosure, the content of the third polymer binder may be about 20 parts by weight or less based on 100 parts by weight of the coating layer. For example, the content of the third polymer binder may be more than about 0 parts by weight and 20 parts by weight or less, about 1 part by weight to 15 parts by weight, about 2 parts by weight to 10 parts by weight, about 2 parts by weight to 8 parts by weight, or about 2 parts by weight to 5 parts by weight, based on 100 parts by weight of the coating layer 130. By adjusting the content of the third polymer binder in this range, the mechanical properties of the coating layer may be improved, the porosity of the coating layer may be maintained, and the heat resistance of the coating layer may be improved.

According to an embodiment of the present disclosure, the content of the inorganic particles usable in the coating layer 130 may be about 80 parts by weight or more based on 100 parts by weight of the coating layer 130. For example, the content of the inorganic particles may be about 80 parts by weight or more and less than 100 parts by weight, 83 parts by weight to 99 parts by weight, 85 parts by weight to 98 parts by weight, 90 parts by weight to 98 parts by weight, or 95 parts by weight to 97 parts by weight, based on 100 parts by weight of the coating layer. By adjusting the content of the inorganic particles in this range, the heat resistance and the mechanical properties of the separator 100 may be improved.

According to an embodiment of the present disclosure, the inorganic particles usable in the coating layer 130 are not particularly limited as long as they are electrochemically stable. That is, the inorganic particles that may be used in an embodiment of the present disclosure are not particularly limited as long as oxidation and/or reduction reactions do not occur in an operation voltage range of the applied electrochemical device (e.g., 0 V to 5 V based on Li/Li+).

According to an embodiment of the present disclosure, non-limiting examples of the inorganic particles usable in the coating layer 130 include BaTiO₃, Pb(Zr,Ti)O₃ (PZT), b₁₋ₓLaₓZr_{1-y}Ti_{y}O₃ (PLZT, 0<x<1, 0<y<1), Pb(Mg_{1/3}Nb_{2/3})O₃—PbTiO₃ (PMN-PT), hafnia (HfO₂), SrTiO₃, SnO₂, CeO₂, MgO, Mg(OH)₂, NiO, CaO, ZnO, ZrO₂, SiO₂, Y₂O₃, Al₂O₃, SiC, Al(OH)₃, TiO₂, aluminum peroxide, zinc tin hydroxide (ZnSn(OH)₆), tin-zinc oxide (Zn₂SO₄, ZnSnO₃), antimony trioxide (Sb₂O₃), antimony tetraoxide (Sb₂O₄), and antimony pentoxide (Sb₂O₅), and the inorganic particles may include at least one, or two or more thereof.

According to an embodiment of the present disclosure, the average diameter D₅₀ of the inorganic particles is not particularly limited, but may be in the range of about 0.3 μm to 1 μm in order to form the coating layer having the uniform thickness and ensure an appropriate porosity. For example, when the average diameter is less than about 0.3 μm, the dispersibility of the inorganic particles in a slurry prepared to form the coating layer may deteriorate, and when the average diameter exceeds about 1 μm, the thickness of the formed coating layer may increase.

In the descriptions herein, the “particle diameter D₅₀” refers to the particle diameter at the 50% point in the cumulative distribution of the number of particles according to particle diameters. The particle diameter may be measured using a laser diffraction method. For example, powder to be measured is dispersed in a dispersion medium, and then, introduced into a commercially available instrument for the laser diffraction particle size measurement (e.g., Microtrac S3500) to measure the difference in diffraction patterns according to particle sizes when the particles pass through the laser beam, and calculate a particle size distribution. In the measurement instrument, the particle diameter D₅₀ may be measured by calculating the particle diameter at the point corresponding to 50% of the cumulative distribution of the number of particles according to particle diameters.

According to an embodiment of the present disclosure, the thickness of the coating layer 130 on either side of the porous polymer substrate 110 may be about 5.0 μm or less. For example, the thickness of the coating layer 130 may be more than about 0 μm and 5.0 μm or less, about 0.5 μm to 4.5 μm, about 1.0 μm to 4.0 μm, about 1.2 μm to 3.8 μm, about 1.4 μm to 3.6 μm, about 1.5 μm to 3.5 μm, about 1.7 μm to 3.4 μm, about 2.0 μm to 3.3 μm, about 2.2 μm to 3.2 μm, or about 2.5 μm to 3.1 μm. By adjusting the thickness of the coating layer in this range, the heat resistance of the separator 100 may be improved, and the energy density may be increased.

According to an embodiment of the present disclosure, the electrochemical device separator 100 includes the adhesive layer 150 provided on the coating layer 130. In this way, the electrochemical device separator 100 includes the adhesive layer 150 provided on the coating layer 130, so that the adhesion between the electrodes and the separator 100 may be ensured during the lamination of the separator 100 with respect to the electrodes.

According to an embodiment of the present disclosure, the adhesive layer 150 including the first polymer binder 151 and the second polymer binder 153 is provided on the coating layer 130. According to an embodiment, the first polymer binder includes a water-soluble polymer binder. In this way, the adhesive layer 150 includes the water-soluble polymer binder as the first polymer binder, so that the adhesion between the electrodes and the separator 100 may be enhanced. Simultaneously with the enhancement of the adhesion between the separator 100 and the electrodes, the increase in air permeability and resistance of the separator 100 may be suppressed.

According to an embodiment of the present disclosure, the second polymer binder 153 may be a water-insoluble polymer binder. The water-insoluble polymer binder may be an emulsion dispersed in water, or a binder in the form dispersed in water by a suspension polymerization or a post-processing. In this way, the second polymer binder includes the water-insoluble polymer binder, so that the porosity of the adhesive layer may be maintained, and the adhesion to the electrodes may be enhanced.

According to an embodiment of the present disclosure, the particle diameter D₅₀ of the second polymer binder 153 may be in the range of about 0.2 μm to 1 μm. In this range, the dispersibility of the second polymer binder in a slurry prepared to form the adhesive layer may be maintained, and the increase in thickness of the formed adhesive layer may be prevented or suppressed.

According to an embodiment of the present disclosure, the content ratio of the first polymer binder 151 and the second polymer binder 153 may be about 1:99 to 19:81. For example, the content ratio of the first polymer binder and the second polymer binder may be about 1:99 to 18:82, about 1:99 to 17:83, about 1:99 to 16:84, about 1:99 to 15:85, about 1:99 to 14:86, about 1:99 to 13:87, about 1:99 to 12:88, or about 1:99 to 11:89, and may be about 1:99 to 10:90 according to an embodiment. In this range, the increase in air permeability and resistance of the separator may be suppressed, and the adhesion between the separator and the electrodes may be enhanced.

According to an embodiment of the present disclosure, the first polymer binder 151 may be one selected from polyacrylic acid (PAA), polyacrylamide (PAM), polyvinyl alcohol (PVA), a phosphoric acid ester-based copolymer, a phosphoric acid acrylic-based copolymer, a polyacrylate-based copolymer, and combinations thereof. According to an embodiment, the first polymer binder may be polyacrylic acid (PAA). The first polymer binder is selected in the range described above, so that the adhesion of the separator may be enhanced.

According to an embodiment of the present disclosure, the second polymer binder 153 may be a polyvinylidene-based binder or an acrylic-based binder.

According to an embodiment of the present disclosure, the second polymer binder 153 may be the acrylic-based binder. The porosity of the separator 100 may be maintained, the adhesion between the electrodes and the separator 100 during the battery lamination process may be enhanced, which may improve the ease of the manufacturing of the battery, and a stacking process may be stably performed.

According to an embodiment of the present disclosure, the acrylic-based binder is a polymer including carboxylic acid ester as a repeating unit, and may be, for example, a (meth)acrylic acid ester or an acrylic-styrene copolymer.

According to an embodiment of the present disclosure, examples of the (meth)acrylic acid ester include (meth)acrylic acid methyl, (meth)acrylic acid ethyl, (meth)acrylic acid n-propyl, (meth)acrylic acid i-propyl, (meth)acrylic acid n-butyl, (meth)acrylic acid i-butyl, (meth)acrylic acid n-amyl, (meth)acrylic acid i-amyl, (meth)acrylic acid hexyl, (meth)acrylic acid cyclohexyl, (meth)acrylic acid 2-ethylhexyl, (meth)acrylic acid n-octyl, (meth)acrylic acid nonyl, (meth)acrylic acid decyl, (meth)acrylic acid hydroxymethyl, (meth)acrylic acid hydroxyethyl, (meth)acrylic acid ethylene glycol, di(meth)acrylic acid ethylene glycol, di(meth)acrylic acid propylene glycol, tris(meth)acrylic acid trimethylolpropane, tetra(meth)acrylic acid pentaerythritol, hexa(meth)acrylic acid dipentaerythritol, (meth)acrylic acid allyl, and di(meth)acrylic acid ethylene, and the (meth)acrylic acid ester may be at least one selected therefrom. The (meth)acrylic acid ester may be at least one selected from (meth)acrylic acid methyl, (meth)acrylic acid ethyl, and (meth)acrylic acid 2-ethylhexyl, and may be, for example, (meth)acrylic acid methyl.

According to an embodiment of the present disclosure, the acrylic-styrene copolymer may include an acrylic-based binder, and the acrylic-based binder may be a polyacrylate-based binder. For example, the binder may be at least one selected from a styrene-butadiene rubber, a nitrile-butadiene rubber, an acrylonitrile-butadiene rubber, an acrylonitrile-butadiene-styrene rubber, and an acrylate-based polymer, and particularly, may be a copolymer including acrylate.

According to an embodiment of the present disclosure, the polyvinylidene-based binder included in the second polymer binder 153 may be a polyvinylidene difluoride (PVdF)-based binder. In this way, the polyvinylidene difluoride-based binder is selected as the polyvinylidene-based binder, so that the resistance of the separator 100 may be reduced.

According to an embodiment of the present disclosure, the polyvinylidene-based binder may be a copolymer of polyvinylidene fluoride and hexafluoropropylene (PVdF-co-HFP, poly(vinylidene fluoride-co-hexafluoropropylene)). In this way, the copolymer of polyvinylidene fluoride and hexafluoropropylene is selected as the polyvinylidene-based binder, so that the dissolution of the polymer binder by the electrolyte may be minimized.

According to an embodiment of them present disclosure, in the polyvinylidene-based binder included in the second polymer binder 153, the content of hexafluoropropylene may be about 5 wt % or more. For example, in the polyvinylidene-based binder included in the third polymer binder, the content of hexafluoropropylene may be about 10 wt % to 80 wt %, about 15 wt % to 75 wt %, about 20 wt % to 70 wt %, about 25 wt % to 65 wt %, about 30 wt % to 60 wt %, about 35 wt % to 55 wt %, or about 40 wt % to 50 wt %. By adjusting the content of hexafluoropropylene included in the polyvinylidene-based binder of the third polymer binder in this range, the resistance of the separator 100 may be reduced. The content of the hexafluoropropylene (HFP) monomer may be measured by 1H-NMR and/or 19F-NMR.

According to an embodiment of the present disclosure, the thickness of the adhesive layer 150 may be about 3.0 μm or less. For example, the thickness of the adhesive layer may be more than about 0.1 μm and 3.0 μm or less, about 0.1 μm to 2.8 μm, about 0.2 μm to 2.6 μm, about 0.3 μm to 2.4 μm, about 0.4 μm to 2.2 μm, about 0.5 μm to 2.0 μm, about 0.6 μm to 1.8 μm, about 0.7 μm to 1.6 μm, about 0.8 μm to 1.4 μm, about 0.9 μm to 1.2 μm, or about 0.9 μm to 1.1 μm. By adjusting the thickness of the adhesive layer 150 in this range, the adhesion between the separator 100 and the electrodes may be improved, and the increase in air permeability and resistance of the separator may be suppressed.

According to an embodiment of the present disclosure, the thickness ratio between the coating layer 130 and the adhesive layer 150 may be about 1:1 to 3:1. By adjusting the thickness ratio between the coating layer 130 and the adhesive layer 150 in this range, it is possible to contribute to the thinning of the separator and to suppress the increase in air permeability and resistance of the separator.

According to an embodiment of the present disclosure, the adhesion of the separator 100 may be about 10 gf/20 mm or more. For example, the adhesion of the separator 100 may be about 10 gf/20 mm to 60 gf/20 mm, about 20 gf/20 mm to 60 gf/20 mm, about 30 gf/20 mm to 60 gf/20 mm, or about 30 gf/20 mm to 50 gf/20 mm. By adjusting the adhesion of the separator 100 in this range, the performance of the battery may be improved.

According to an embodiment of the present disclosure, the air permeability of the separator 100 may be about 100 sec/100 cc or less. For example, the air permeability of the separator 100 may be about 80 sec/100 cc to 100 sec/100 cc, about 82 sec/100 cc to 99 sec/100 cc, about 84 sec/100 cc to 98 sec/100 cc, about 85 sec/100 cc to 98 sec/100 cc, about 86 sec/100 cc to 98 sec/100 cc, or about 88 sec/100 cc to 97 sec/100 cc. By adjusting the air permeability of the separator 100 in this range, the performance of the battery may be improved.

According to an embodiment of the present disclosure, the resistance (22, ohm) of the separator 100 may be about 0.80 ohm or less. For example, the resistance of the separator 100 may be about 0.60 ohm to 0.80 ohm, about 0.65 ohm to 0.80 ohm, about 0.70 ohm to 0.80 ohm, about 0.70 ohm to 0.78 ohm, about 0.72 ohm to 0.78 ohm, or about 0.72 ohm to 0.77 ohm. By adjusting the resistance of the separator 100 in this range, the performance of the battery may be improved.

An embodiment of the present disclosure includes a method of manufacturing the electrochemical device separator 100 including: preparing the porous polymer substrate 110; coating at least one surface of the porous polymer substrate 110 with a slurry including inorganic particles to form the coating layer 130; and applying a slurry including the first polymer binder 151 and the second polymer binder 153 onto the coating layer 130 to form the adhesive layer 150, wherein the first polymer binder 151 is a water-soluble polymer binder.

According to an embodiment of the present disclosure, the method of manufacturing the electrochemical device separator 100 may enhance the adhesion between the electrodes and the separator 100 and suppress the increase in air permeability and resistance of the separator 100. In the following descriptions of the method of manufacturing the electrochemical device separator 100 according to an embodiment of the present disclosure, overlapping descriptions with the descriptions of the electrochemical device separator 100 above will be omitted.

According to an embodiment of the present disclosure, the method of manufacturing the electrochemical device separator 100 includes applying a slurry including inorganic particles to at least one surface of the porous polymer substrate 110. In this way, the slurry including inorganic particles is applied onto at least one surface of the porous polymer substrate 110, so that the coating layer 130 may be formed, and since the slurry for the coating layer includes the inorganic particles in a large amount, the heat resistance of the separator 100 may be improved.

According to an embodiment of the present disclosure, the method of applying the slurry for the coating layer to the surface of the porous polymer substrate 110 is not particularly limited to a specific method, and a common method well-known in the art may be used. For example, various methods including a dip coating, a die coating, a roll coating, a comma coating, a bar coating, and a combination thereof may be used.

According to an embodiment of the present disclosure, the slurry for the coating layer may further include the third polymer binder. In this way, the slurry for the coating layer further includes the third polymer binder, so that a density difference between the polymer binder particles and the inorganic particles may be adjusted, and the adhesion between the separator 100, including the polymer binder particles, and the electrodes may be enhanced.

According to an embodiment of the present disclosure, prior to applying the slurry for the coating layer, the slurry may be prepared by dissolving the third polymer binder in an appropriate solvent to prepare a polymer solution. The solvent may have a similar solubility index to that of the polymer binder to be used, and a low boiling point. This is to achieve a uniform mixture and facilitate the removal of the solvent thereafter. Non-limiting examples of the solvent that may be used include acetone, tetrahydrofuran, methylene chloride, chloroform, dimethylformamide, N-methyl-2-pyrrolidone (NMP), cyclohexane, water, and mixtures thereof.

According to an embodiment of the present disclosure, prior to applying the slurry for the coating layer, the slurry may be prepared by dispersing the third polymer binder in an appropriate dispersant to prepare a polymer emulsion. A material with a low boiling point may be used as the dispersant. This is to achieve a uniform mixture and facilitate the removal of the dispersant thereafter. Non-limiting examples of the dispersant that may be used include acetone, tetrahydrofuran, methylene chloride, chloroform, dimethylformamide, N-methyl-2-pyrrolidone (NMP), cyclohexane, water, and mixtures thereof.

According to an embodiment of the present disclosure, inorganic particles may be added and dispersed in the polymer emulsion or the polymer solution. The content ratio between the inorganic particles and the polymer binder particles is the same as described above, and may be appropriately adjusted in consideration of the thickness, the pore size, and the porosity of the coating layer according to the final manufactured embodiment of the present disclosure.

According to an embodiment of the present disclosure, the content of solids in the slurry for the coating layer may be about 10 wt % to 40 wt %. For example, the content of solids in the slurry for the coating layer may be about 11 wt % to 38 wt %, about 12 wt % to 36 wt %, about 13 wt % to 34 wt %, about 14 wt % to 32 wt %, about 15 wt % to 30 wt %, about 16 wt % to 28 wt %, about 17 wt % to 26 wt %, about 18 wt % to 24 wt %, or about 19 wt % to 22 wt %. By adjusting the content of solids in the slurry for the coating layer in this range, the increase in resistance of the separator may be prevented or suppressed, and the separator may be manufactured as a thin film so that the energy density of the battery may be improved.

According to an embodiment of the present disclosure, the method of manufacturing the electrochemical device separator 100 includes applying the slurry including the first polymer binder and the second polymer binder onto the coating layer 130. In this way, by including the step of applying the slurry including the first polymer binder and the second polymer binder onto the coating layer 130, the adhesive layer may be easily formed so that the adhesion between the separator 100 and the electrodes may be implemented.

According to an embodiment of the present disclosure, the method of applying the slurry for the adhesive layer onto the coating layer 130 is not particularly limited to a specific method, and a common method well-known in the art may be used. For example, various methods including a dip coating, a die coating, a roll coating, a comma coating, a bar coating, and a combination thereof may be used.

According to an embodiment of the present disclosure, the slurry for the adhesive layer may further include a dispersant, and the dispersant may be water. In this way, the slurry for the adhesive layer further includes the dispersant, so that the second polymer binder may be uniformly dispersed.

According to an embodiment of the present disclosure, the method of manufacturing the electrochemical device separator 100 may include: drying the slurry for the coating layer to form the coating layer 130. In this way, by including the step of drying the slurry for the coating layer to form the coating layer 130, the damage to the coating layer 130 may be minimized, and the solvent or the dispersant included in the slurry may easily be removed.

According to an embodiment of the present disclosure, the method of manufacturing the electrochemical device separator 100 may include: drying the slurry for the adhesive layer to form the adhesive layer 150. In this way, by including the step of drying the slurry for the adhesive layer to form the adhesive layer 150, the damage to the adhesive layer 150 may be minimized, and the dispersant included in the slurry may easily be removed.

According to an embodiment of the present disclosure, the method of manufacturing the electrochemical device separator 100 may include: applying and drying the slurry for the coating layer, and then, drying the slurry for the adhesive layer to prepare the coating layer 130 and the adhesive layer 150 individually. In this way, by including the step of applying and drying the slurry for the coating layer, and then, drying the slurry for the adhesive layer to prepare the coating layer 130 and the adhesive layer 150 individually, the coating layer 130 and the adhesive layer 150 may easily be formed.

According to an embodiment of the present disclosure, a time condition for the drying process is appropriately set to minimize an occurrence of surface defects in the coating layer 130. The drying may be performed using drying aids such as a drying oven and hot air.

According to an embodiment of the present disclosure, the separator 100 is manufactured into an electrode assembly by the lamination process in which the separator 100 is interposed between the negative electrode and the positive electrode, and heat and/or a pressure is applied to adhere the separator and the electrodes. In an embodiment of the present disclosure, the lamination process may be performed by a roll press apparatus including a pair of press rollers. For example, the negative electrode, the separator 130, and the positive electrode may be sequentially laminated, and inserted between the press rollers to implement the inter-layer adhesion. In this case, the lamination process may be performed by a hot pressing method.

An embodiment of the present disclosure includes an electrochemical device including a positive electrode; a negative electrode; a separator interposed between the positive electrode and the negative electrode; and an electrolyte, wherein the separator is any one of the separators described above.

The electrochemical device according to an embodiment of the present disclosure may improve the battery performance.

In the descriptions herein, a cylindrical secondary battery, which is the electrochemical device, is a device that converts chemical energy into electrical energy through an electrochemical reaction, and encompasses primary batteries and secondary batteries in concept. In the descriptions herein, the secondary battery may be charged and discharged, and indicates, for example, a lithium secondary battery, a nickel-cadmium battery, or a nickel-hydrogen battery. The lithium secondary battery uses lithium ions as an ion conductor, and examples thereof include, but not limited to, a non-aqueous electrolyte secondary battery having a liquid electrolyte, an all-solid-state battery having a solid electrolyte, a lithium polymer battery having a gel polymer electrolyte, and a lithium metal battery using a lithium metal as the negative electrode.

According to an embodiment of the present disclosure, the positive electrode includes: a positive electrode collector; and a positive electrode active material layer disposed on at least one surface of the collector and including a positive electrode active material, a conductive material, and a binder resin. The positive electrode active material may include one compound or a mixture of two or more compounds among a layered compound or a compound substituted with one or more transition metals, such as lithium manganese complex oxides (e.g., LiMn₂O₄ and LiMnO₂), lithium cobalt oxides (e.g., LiCoO₂), and lithium nickel oxides (e.g., LiNiO₂); lithium manganese oxides such as compounds of the formula Li₁₊ₓMn₂₋ₓO₄ (where x represents 0 to 0.33), LiMnO₃, LiMn₂O₃, and LiMnO₂; lithium copper oxides (e.g., Li₂CuO₂); vanadium oxides such as LiV₃O₈, LiV₃O₄, V₂O₅, and Cu₂V₂O₇; Ni-site lithium nickel oxides expressed by the formula LiNi₁₋ₓMₓO₂ (where M=Co, Mn, Al, Cu, Fe, Mg, B, or Ga, and x=0.01 to 0.3); lithium manganese complex oxides expressed by the formula LiMn₁₋ₓMₓO₂ (where M=Co, Ni, Fe, Cr, Zn, or Ta, and x=0.01 to 0.1) or Li₂Mn₃MO₈ (where M=Fe, Co, Ni, Cu, or Zn); LiMn₂O₄ where the Li portion of the formula is substituted with alkaline earth metal ions; disulfide compounds; and Fe₂(MoO₄)₃.

According to an embodiment of the present disclosure, the negative electrode includes: a negative electrode collector; and a negative electrode active material layer disposed on at least one surface of the collector and including a negative electrode active material, a conductive material, and a binder resin. The negative electrode may include, as the negative electrode active material, one species or a mixture of two or more species selected from lithium metal oxides and carbon such as hard carbon and graphitic carbon; metal complex oxides such as LiₓFe₂O₃ (0≤x≤1), LiₓWO₂ (0≤x≤1), and SnₓMe₁₋ₓMe′_{y}O_{z} (Me: Mn, Fe, Pb, Ge; Me′: Al, B, P, Si; the elements of Groups 1, 2, 3 of the periodic table, halogen; 0<x≤1; 1≤y≤3; 1≤z≤δ); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; Li—Co—Ni-based materials; and titanium oxides.

According to an embodiment of the present disclosure, the conductive material may be, for example, any one or a mixture of two or more conductive materials selected from graphite, carbon black, carbon fiber or metal fiber, metal powder, conductive whisker, conductive metal oxides, activated carbon, and polyphenylene derivatives. According to an embodiment, the conductive material may be one or a mixture of two or more species selected from natural graphite, artificial graphite, super-p, acetylene black, Ketjen black, channel black, furnace black, lamp black, summer black, denka black, aluminum powder, nickel powder, zinc oxide, potassium titanate, and titanium oxides.

According to an embodiment of the present disclosure, the collector is not particularly limited as long as it has a high conductivity without causing chemical changes in the battery, and may be, for example, a stainless steel, copper, aluminum, nickel, titanium, calcined carbon, or aluminum or a stainless steel with its surface processed with carbon, nickel, titanium, silver, or the like.

According to an embodiment of the present disclosure, the binder resin may be a polymer commonly used for the electrodes in the art. Non-limiting examples of the binder resin include polyvinylidene fluoride-co-hexafluoropropylene, polyvinylidene fluoride-co-trichloroethylene, polymethylmethacrylate, polyetylhexyl acrylate, polybutyl acrylate, polyacrylonitrile, polyvinyl pyrrolidone, polyvinyl acetate, polyethylene-co-vinyl acetate, polyethylene oxide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, and carboxyl methyl cellulose, but are not limited thereto.

In the present disclosure, the positive electrode slurry for preparing the positive electrode active material layer may include a dispersant, and the dispersant may be a pyrrolidone-based compound. For example, the dispersant may be N-methylpyrrolidone (ADC-01, EG Chem Ltd.).

According to an embodiment of the present disclosure, the content of the dispersant included in the positive electrode slurry may be more than about 0 parts by weight and 0.5 parts by weight or less based on 100 parts by weight of the positive electrode slurry. For example, the content of the dispersant included in the positive electrode slurry may be more than about 0.05 parts by weight and 0.4 parts by weight or less based on 100 parts by weight of the positive electrode slurry.

According to an embodiment of the present disclosure, the negative electrode slurry for preparing the negative electrode active material layer may include a dispersant, which may be a pyrrolidone-based compound. For example, the dispersant may be polyvinylpyrrolidone (Junsei in Japan).

According to an embodiment of the present disclosure, the content of the dispersant included in the negative electrode slurry may be more than about 0 parts by weight and 0.5 parts by weight or less based on 100 parts by weight of the negative electrode slurry. For example, the content of the dispersant included in the negative electrode slurry may be more than about 0.05 parts by weight and 0.4 parts by weight or less based on 100 parts by weight of the negative electrode slurry.

According to an embodiment of the present disclosure, the electrochemical device may further include an electrolyte.

According to an embodiment of the present disclosure, the electrochemical device prepared as described above is mounted into a suitable case, and the electrolyte is injected into the case to manufacture a battery.

According to an embodiment of the present disclosure, the electrolyte may be, but not limited to, an electrolyte solution obtained by dissolving or dissociating a salt having, for example, the structure of A⁺B⁻ in an organic solvent, in which A⁺ includes ions consisting of alkali metal cations such as Li⁺, Na⁺, and K⁺, or combinations thereof, and B⁻ includes ions consisting of anions such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, C(CF₂SO₂)₃⁻, or combinations thereof, and the organic, solvent includes propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (γ-butyrolactone), or a mixture thereof.

According to an embodiment of the present disclosure, the electrolyte may include one solvent selected from ethylene carbonate (EC), diethyl carbonate (DEC), dimethyl carbonate (DMC), ethyl methyl carbonate (EMC), and combinations thereof.

An embodiment of the present disclosure provides a battery module that includes, as a unit battery, a battery including the electrochemical device described above, a battery pack including the battery module, and a device including the battery pack as a power source. Examples of the device include, but are not limited to, power tools powered by an electric motor; electric vehicles including electric vehicles (EV), hybrid electric vehicles (HEV), and plug-in hybrid electric vehicles (PHEV); electric two-wheeled vehicles including electric bicycles (E-bikes), and electric scooters (E-scooters); electric golf carts; and power storage systems.

Hereinafter, the present disclosure will be described in detail using Examples. However, embodiments according to the present disclosure may be modified in various ways, and the scope of the present disclosure should not be construed as being limited to the Examples. The Examples will be described herein below to more comprehensively describe the invention to one having ordinary skill in the art.

### Example 1

A polyethylene resin (weight average molecular weight of 900,000) was extruded and subjected to a wet process to manufacture a porous polymer substrate (total thickness of about 9 μm).

As the inorganic particles, Al₂O₃ powder with a particle diameter D₅₀ of 500 nm was prepared. As the third polymer binder, an acrylic-based emulsion (CSB-130, Toyo Ink Co.) was prepared, and as the dispersant, sodium carboxymethyl cellulose (CMC-Na) (SG-L02, GL Chem Co., Ltd.) was prepared.

The prepared inorganic particles, third polymer binder, and dispersant were added to water in a weight ratio of 97:2:1, and then, the inorganic particles were added, crushed, and dispersed to prepare a slurry for a coating layer.

The slurry for the coating layer was coated on both surfaces of the porous polymer substrate, and dried to form a coating layer with a thickness of 3 μm.

Polyacrylic acid (PAA, Miwon Commercial Co., Ltd., SBS10), which is a water-soluble polymer, was prepared as the first polymer binder, and PVDF (Arkema, LBG2200), which is a water-insoluble polymer, was prepared as the second polymer binder. The first polymer binder and the second polymer binder were prepared in the content of 5:95 wt %, and added to water to prepare a slurry for an adhesive layer with a total solids content of 5%.

The slurry for the adhesive layer was applied onto the coating layer at a loading amount of 0.5 g/m² to 1.0 g/m², and then, dried thereby forming the adhesive layer with a thickness of 1 μm, to manufacture an electrochemical device separator.

### Example 2

An electrochemical device separator was prepared in the same manner as in Example 1, except that an acrylic-based emulsion (BM2510, ZEON Corporation) was used as the water-insoluble polymer that was the second polymer binder.

### Example 3

An electrochemical device separator was prepared in the same manner as in Example 2, except that the content of the first polymer binder and the second polymer binder was 10:90.

### Example 4

An electrochemical device separator was prepared in the same manner as in Example 2, except that the content of the first polymer binder and the second polymer binder was 1:99.

### Example 5

An electrochemical device separator was prepared in the same manner as in Example 1, except that the thickness of the coating layer was 1 μm, and the thickness of the adhesive layer was 1 μm.

### Comparative Example 1

An electrochemical device separator was prepared in the same manner as in Example 1, except that polyacrylic acid (PAA) was not used as the water-soluble polymer that was the first polymer binder.

### Comparative Example 2

An electrochemical device separator was prepared in the same manner as in Example 2, except that polyacrylic acid (PAA) was not used as the water-soluble polymer that was the first polymer binder.

### Comparative Example 3

An electrochemical device separator was prepared in the same manner as in Example 1, except that instead of polyacrylic acid used in Example 1 as the water-soluble polymer that was the first polymer binder, an acrylic-based emulsion (BM2510, ZEON Corporation), which was the water-insoluble polymer, was used.

### Comparative Example 4

An electrochemical device separator was prepared in the same manner as in Example 1, except that the content of the first polymer binder and the second polymer binder was 20:80.

### Comparative Example 5

An electrochemical device separator was prepared in the same manner as in Example 2, except that the content of the first polymer binder and the second polymer binder was 20:80.

### Comparative Example 6

An electrochemical device separator was prepared in the same manner as in Example 1, except that the thickness of the coating layer was 4 μm and the thickness of the adhesive layer was 1 μm.

### <Manufacture of Electrochemical Device>

### 1) Manufacture of Positive Electrode

A positive electrode active material (LiNi_{0.8}Mn_{0.1}Co_{0.1}O₂), a conductive material (carbon black), a dispersant (N-methylpyrrolidone, ADC-01, LG Chem Ltd.), and a binder resin (a mixture of PVDF-HFP and PVDF) were mixed with water in a weight ratio of 97.5:0.7:0.14:1.66 to prepare a slurry for a positive electrode active material layer with a concentration of 50 wt % of the remaining components excluding water. Then, the slurry was applied to the surface of an aluminum thin film (thickness of 10 μm), and dried to manufacture a positive electrode including the positive electrode active material layer (thickness of 120 μm).

### 2) Manufacture of Negative Electrode

Graphite (a blend of natural graphite and artificial graphite), a conductive material (carbon black), a dispersant (polyvinylpyrrolidone, Junsei Chemical Co., Ltd., Japan), and a binder resin (a blend of PVDF-HFP and PVDF) were mixed with water in a weight ratio of 97.5:0.7:0.14:1.66 to prepare a slurry for a negative electrode active material layer with a concentration of 50 wt % of the remaining components excluding water. Then, the slurry was applied to the surface of a copper thin film (thickness of 10 μm), and dried to manufacture a negative electrode including the negative electrode active material layer (thickness of 120 μm).

### 3) Lamination Process

The separator of each of the Examples and the Comparative Examples was interposed between the negative electrode and the positive electrode prepared as described above, and a lamination process was performed to obtain an electrode assembly. The lamination process was performed using a hot press under conditions of 60° C. and 6.5 MPa for 1 second.

### Experimental Examples

### Measurement of Adhesion Between Electrode and Separator

The separator of each of the Examples and the Comparative Examples was cut into 70 mm (length)×20 mm (width), and the prepared electrode and separator were laminated using a press under conditions of 60° C., 6.5 MPa, and 1 sec to prepare a specimen. The prepared specimen was attached and fixed to a glass plate using a double-sided tape with the electrode facing the glass plate. The separator side of the specimen was peeled at an angle of 180° at 150 mm/min at 25° C., and the strength was measured.

### Measurement of Air Permeability of Separator

The air permeation time (air permeability, Gurley) of the separator in each of the Examples and the Comparative Examples was measured by the ASTM D726-94 method. Gurley refers to a resistance to airflow, and is measured by a Gurley densometer. The value of air permeability described herein is represented by the passage time (sec) of 100 cc of air through the 1 in² cross section of the separator under a pressure of 12.2 in H₂O, i.e., air permeation time.

### Measurement of Resistance of Separator

Each separator substrate of the Examples and the Comparative Examples was interposed between SUS, an electrolyte was injected thereinto to manufacture a coin cell, and the resistance (ER) of the separator was measured by the EIS method. At this time, the frequency was set to the range of 100,000 Hz to 10,000 Hz. The electrolyte was obtained by mixing LiPF₆ at a concentration of 1 M in a non-aqueous solvent in which ethylene carbonate (EC) and ethyl methyl carbonate (EMC) were mixed at 3:7.

TABLE 1

| | | | | | | | Comp. | Comp. | Comp. | Comp. | Comp. | Comp. |
|---|---|---|---|---|---|---|---|---|---|---|---|---|
| | | Ex. | Ex. | Ex. | Ex. | Ex. | Ex. | Ex. | Ex. | Ex. | Ex. | Ex. |
| | | 1 | 2 | 3 | 4 | 5 | 1 | 2 | 3 | 4 | 5 | 6 |
| Adhesive | Binder | PAA | PAA | PAA | PAA | PAA | — | — | Acryl | PAA | PAA | PAA |
| layer | 1 | | | | | | | | | | | |
| binder | Binder | PVDF | Acryl | Acryl | Acryl | PVDF | PVDF | Acryl | PVDF | PVDF | Acryl | PVDF |
| | 2 | | | | | | | | | | | |
| | Content | 5/95 | 5/95 | 10/90 | 1/99 | 5/95 | 0/100 | 0/100 | 5/95 | 20/80 | 20/80 | 5/95 |
| | of | | | | | | | | | | | |
| | binders | | | | | | | | | | | |
| | 1 | | | | | | | | | | | |
| | and 2 | | | | | | | | | | | |
| | (wt %) | | | | | | | | | | | |
| Separator | Electrode- | 35 | 42 | 50 | 30 | 36 | 12 | 15 | 16 | 45 | 58 | 35 |
| performance | separator | | | | | | | | | | | |
| | adhesion | | | | | | | | | | | |
| | (gf/20 | | | | | | | | | | | |
| | mm) | | | | | | | | | | | |
| | Air | 95 | 92 | 97 | 90 | 88 | 85 | 80 | 86 | 125 | 128 | 110 |
| | permeability | | | | | | | | | | | |
| | of | | | | | | | | | | | |
| | separator | | | | | | | | | | | |
| | (sec/ | | | | | | | | | | | |
| | 100cc) | | | | | | | | | | | |
| | Separator | 0.75 | 0.75 | 0.77 | 0.74 | 0.72 | 0.70 | 0.67 | 0.70 | 0.92 | 0.95 | 0.86 |
| | resistance | | | | | | | | | | | |
| | (Ω) | | | | | | | | | | | |
| Evaluation | | | | | | | inferior | inferior | inferior | increase of | increase of | increase of |
| result | | | | | | | adhesion | adhesion | adhesion | air | air | air |
| | | | | | | | | | | permeability/ | permeability/ | permeability/ |
| | | | | | | | | | | resistance | resistance | resistance |

From Table 1 above, it may be verified that in Examples 1 to 5 according to an embodiment of the present disclosure, the adhesion between the electrode and the separator is enhanced, and both the air permeability and the resistance of the separator are superior.

Meanwhile, it may be seen that in Comparative Examples 1 to 3, the use of only the water-insoluble polymer results in the decrease in adhesion between the electrode and the separator. It may be seen that in Comparative Examples 4 and 5, the excessive amount of water-soluble polymer results in the increase in air permeability and resistance of the separator. It may be seen that in Comparative Example 6, as the thickness of the coating layer increases relative to the thickness of the adhesive layer, the air permeability and the resistance of the separator increases.

Therefore, the electrochemical device separator 100 according to an embodiment of the present disclosure includes the water-soluble polymer in a small amount in the adhesive layer 150, so that the adhesion between the electrodes and the separator 100 may be improved, and the increase in air permeability and resistance of the separator 100 may be suppressed.

While the embodiments of the present disclosure have been described, it will be appreciated by one of ordinary skill or knowledge in the art that the embodiments of the present disclosure may be changed or modified in various ways within the scope that does not depart from the technical scope of the various embodiments of the present disclosure defined in the claims attached herein below. Therefore, the technical scope of the various embodiments of the present disclosure is not limited to that in the Detailed Description section above, and may be defined by the claims.

### DESCRIPTION OF SYMBOLS

100: separator
110: porous polymer substrate
130: coating layer
150: adhesive layer
151: first polymer binder
153: second polymer binder

What is claimed is:

1. An electrochemical device separator comprising:
a porous polymer substrate;
a coating layer provided on at least one surface of the porous polymer substrate, and including inorganic particles; and
an adhesive layer including a first polymer binder and a second polymer binder on the coating layer,
wherein the first polymer binder is a water-soluble polymer binder.

2. The electrochemical device separator according to claim 1, wherein the second polymer binder is a water-insoluble polymer binder.

3. The electrochemical device separator according to claim 1, wherein a content ratio of the first polymer binder and the second polymer binder is 1:99 to 19:81.

4. The electrochemical device separator according to claim 1, wherein the first polymer binder is one selected from polyacrylic acid (PAA), polyacrylamide (PAM), polyvinyl alcohol (PVA), a phosphoric acid ester-based copolymer, a phosphoric acid acrylic-based copolymer, a polyacrylate-based copolymer, and combinations thereof.

5. The electrochemical device separator according to claim 1, wherein the second polymer binder is a polyvinylidene-based binder or an acrylic-based binder.

6. The electrochemical device separator according to claim 1, wherein a content of the inorganic particles in the coating layer is 80 parts by weight or more based on 100 parts by weight of the coating layer.

7. The electrochemical device separator according to claim 1, wherein a thickness ratio of the coating layer and the adhesive layer is 1:1 to 3:1.

8. The electrochemical device separator according to claim 1, wherein a thickness of the coating layer is 5.0 μm or less.

9. The electrochemical device separator according to claim 1, wherein a thickness of the adhesive layer is 3.0 μm or less.

10. The electrochemical device separator according to claim 1, wherein an adhesion of the electrochemical device separator is 10 gf/20 mm or more.

11. The electrochemical device separator according to claim 1, wherein an air permeability of the electrochemical device separator is 100 sec/100 cc or less.

12. The electrochemical device separator according to claim 1, wherein a resistance of the electrochemical device separator is 0.80 ohm or less.

13. A method of manufacturing an electrochemical device separator, the method comprising:
preparing a porous polymer substrate;
coating at least one surface of the porous polymer substrate with a slurry including inorganic particles to form a coating layer; and
applying a slurry including a first polymer binder and a second polymer binder onto the coating layer to form an adhesive layer,
wherein the first polymer binder is a water-soluble polymer binder.

14. An electrochemical device comprising:
a positive electrode;
a negative electrode;
a separator interposed between the positive electrode and the negative electrode; and
an electrolyte,
wherein the separator is the electrochemical device separator according to claim 1.

15. The electrochemical device according to claim 14, wherein the electrolyte is an electrolyte including one solvent selected from ethylene carbonate (EC), diethyl carbonate (DEC), dimethyl carbonate (DMC), ethyl methyl carbonate (EMC), and combinations thereof.
